(19) United States
(12) Patent Application Publication
(10) Pub. No.: US 2020/0055657 A1
(43) Pub. Date: Feb. 20, 2020

(54) ABSORBENT TRAY WITH COATING

(71) Applicant: Emery Silfurtun Inc., Markham (CA)

(72) Inventor: Fridrik R. Jonsson, Reykjavik (IS)

(21) Appl. No.: 16/661,110

(22) Filed: Oct. 23, 2019

Related U.S. Application Data
(63) Continuation of application No. PCT/CA2018/050492, filed on Apr. 27, 2018.
(60) Provisional application No. 62/491,352, filed on Apr. 28, 2017.

(51) Int. Cl. B65D 81/26; B01J 20/28; B01J 20/22

(52) U.S. Cl. CPC B65D 81/264; B01J 2220/485; B01J 20/22; B01J 20/28038

(57) ABSTRACT

A tray has an integral inner layer having an inner surface and an exterior surface. The inner layer has a substantially planar base portion and a wall portion extending upwardly from at least a portion of a perimeter of the base portion. An outer layer applied to the exterior surface of the inner layer comprises a liquid-impermeable coating. The inner layer consists of an absorbent paperboard, and the outer layer is adapted to inhibit liquid absorbed in the inner layer from leaking through the tray. The tray may be useful in the retail display of meat or produce.

### CROSS-REFERENCE TO RELATED APPLICATIONS

This application is a Continuation of International Application No. PCT/CA2018/050492, filed on Apr. 27, 2018, which claims the benefit of U.S. Provisional Application No. 62/491,352, filed on Apr. 28, 2017, the disclosures of which are incorporated herein by reference.

### FIELD

This disclosure relates generally to trays for packaging food products (e.g. meat or produce) for sale, and more specifically to paperboard trays.

### INTRODUCTION

Trays for packaging meat or produce for sale are well known. Such trays typically have an inner layer (i.e. the surface that is, in use, in contact with meat or produce) that is liquid impermeable. Typically, this liquid impermeability is due to the tray being made from a non-absorbent or liquid impermeable material (e.g. polystyrene), and/or the inner surface being coated or otherwise treated to prevent liquids (e.g. blood or other meat juices) from soaking through the tray.

Also, it is common for meat trays that have a non-absorbent or liquid impermeable inner layer to be provided with a separate pad or liner to absorb liquids released by the meat, to increase the aesthetic appearance of the meat for retail display, and/or to improve the shelf-life of the packaged meat.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with one aspect of this disclosure, a paperboard or pulp-molded tray for packaging meat, produce, or other contents for which liquid can be released is provided. The tray has an uncoated inner layer to which sizing has been incorporated or applied to provide a desired absorption profile. In use, liquids released by meat or other food products placed in the tray may be absorbed into the inner paperboard layer. Providing an absorbent inner surface may have one or more advantages. For example, it may obviate the need for an absorbent pad, as is typically used in meat trays made of polystyrene or other non-absorbent materials.

An outer layer is applied to the exterior or bottom surface of the inner layer to inhibit liquid absorbed by the inner layer from leaking through the tray. Providing an outer layer that includes a liquid-impermeable coating on the exterior surface of the inner layer may have one or more advantages. For example, as the exterior or lower surface of the tray does not, in normal use, come in contact with the contents of the tray (e.g. meat), the outer layer or coating may not have to be a food-grade coating. Also, after it has been applied to the tray, the liquid-impermeable coating of the outer layer may prevent dyes or other labelling applied to the outer layer from being absorbed by the paperboard. This may allow non-food-grade dyes or other labelling to be printed or otherwise applied directly to the exterior of the tray.

In accordance with a broad aspect, there is provided a tray for inhibiting a liquid from leaking, the tray comprising: an integral inner layer having an inner surface and an exterior surface, the inner layer comprising: a substantially planar base portion, the base portion having a perimeter; and a wall portion extending upwardly from at least a portion of the perimeter; an outer layer applied to the exterior surface of the inner layer, the outer layer comprising a liquid-impermeable coating; wherein the inner layer consists of an absorbent paperboard, and wherein the outer layer is adapted to inhibit liquid absorbed in the inner layer from leaking through the tray.

In some embodiments, the wall portion may extend from the entire perimeter and completely surround the base portion.

In some embodiments, the outer layer may be applied to the entire exterior surface of the inner layer.

In some embodiments, the absorbent paperboard may comprise at least one of virgin wood fiber, food grade waste paper, wheat straw, and sugarcane bagasse.

In some embodiments, the liquid impermeable coating may comprise polylactic acid (PLA).

In some embodiments, each of the absorbent paperboard and the liquid impermeable coating may be biodegradable.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of a prior art polystyrene tray containing a cut of meat and an absorbent pad;

FIG. 2 is a perspective view of a paperboard tray in accordance with one embodiment;

FIG. 3 is schematic cross-section view of the base of the tray of FIG. 2; and

FIG. 4 is a perspective view of the paperboard tray of FIG. 2 in which pieces of meat have been placed.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

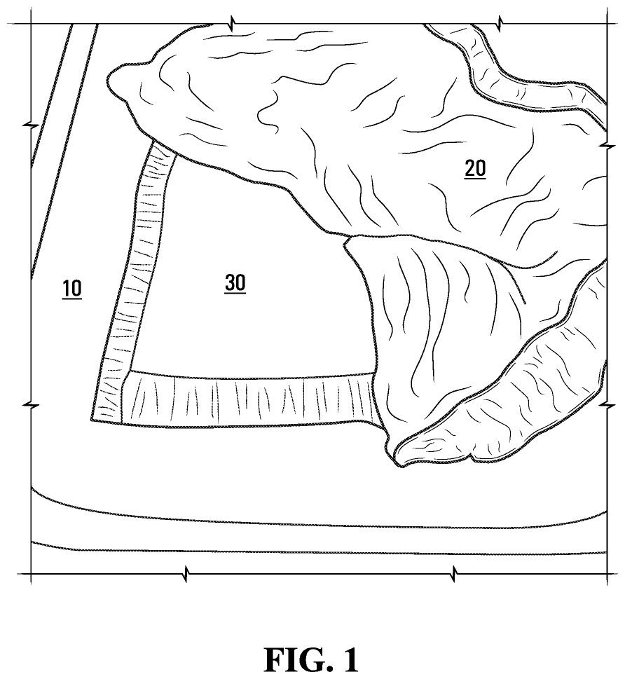

FIG. 1 shows a prior-art meat tray 10 containing a cut of meat 20. The tray is made of polystyrene, which is typically regarded as a non-absorbent material. Accordingly, blood or other juices that may be released from the meat 20 collect on the inner surface of the tray. Typically, an absorbent pad 30 or other liquid control devices are placed in the tray 10 to absorb or otherwise control fluids before placing the meat 20 in the tray, to increase the aesthetic appearance of the packaged meat, and/or to improve its shelf-life.

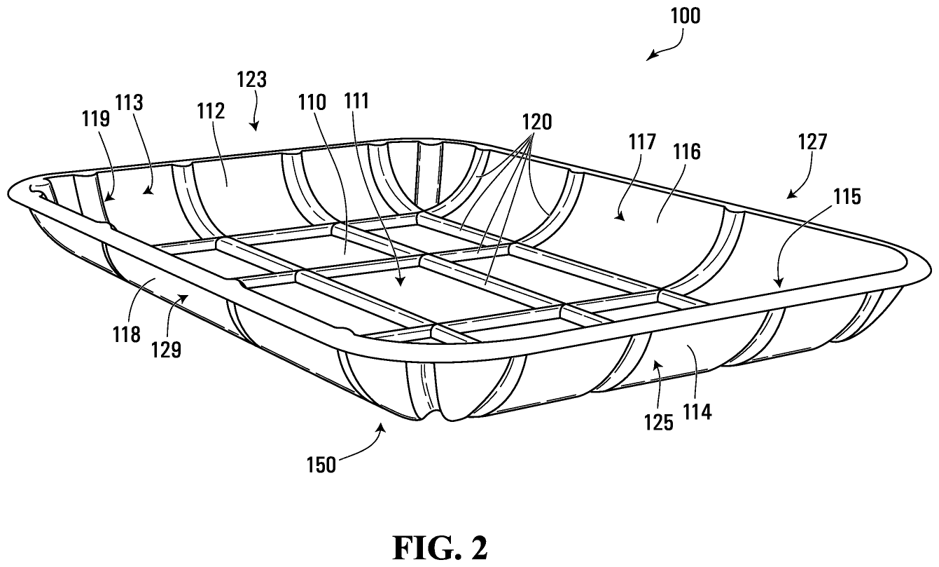

FIG. 2 illustrates a tray 100 for meat or produce according to an embodiment of the present invention. Tray 100 has a rectangular base portion 110, and wall portions 112, 114, 116, 118 extending upwardly from the perimeter of the base 110. An inner surface 111 of the base portion and inwardly facing surfaces 113, 115, 117, and 119 of the wall portions cooperatively define a tray volume into which one or more objects (e.g. meat, poultry, fish, or other food products) may be placed. While the tray in the illustrated example is generally rectangular, it will be appreciated that tray 100 may alternatively be oval, round, or any other desired shape, with more or fewer wall portions as necessary.

In the illustrated example, tray 100 has a number of optional ribs 120 extending across the base portion 100 and up to the wall portions 112, 114, 116, 118. Ribs 120 may improve the structural rigidity of tray 100. It will be appreciated that tray 100 may alternatively be provided without ribs.

The base portion 110 and the wall portions 112, 114, 116, and 118 are an integral inner layer made of a paperboard composition, such as a pulp molded material. The paperboard may be made from virgin pulp, trimmings from food grade paperboard, and/or non-tree fiber such as wheat straw, sugarcane bagasse and the like. Preferably, the paperboard composition is biodegradable (e.g. compostable) and/or recyclable.

The inner surface 111 of the base portion and the inwardly facing surfaces 113, 115, 117, and 119 of the wall members are preferably uncoated paperboard. Thus, liquid that contacts these surfaces may be absorbed by the paperboard inner layer. For example, blood or other juices release from a piece of meat placed in the tray may be absorbed through the inner surface 111 of the base portion 110 and into the inner layer itself. Preferably, one or more sizing additives (e.g. rosin, liquid paraffin wax, alkyl ketene dimer (AKD), alkyl succinic anhydride (ASA), etc.) may be added to the paperboard to provide a desired absorbency profile for the inner layer.

The ability of the paperboard layer to absorb liquids released from objects placed in the tray may have one or more advantages. For example, an absorbent pad as is typically used in non-absorbent (e.g. polystyrene) may not be required. This may increase the cost effectiveness of the tray.

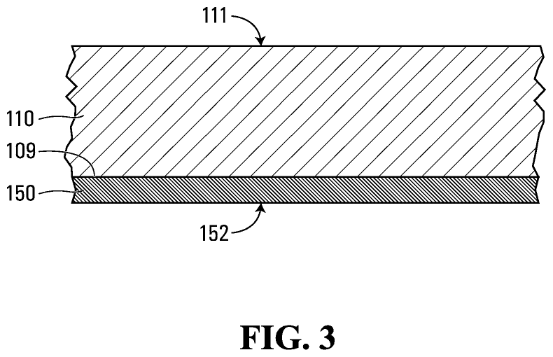

Turning to FIG. 3, tray 100 also has an outer layer 150 that includes a liquid-impermeable coating applied to the lower or exterior surface 109 of the base portion 110 of the inner layer, and optionally to one or more of the outwardly facing surfaces 123, 125, 127, and 129 of the wall portions 112, 114, 116, and 118. In one embodiment, the outer layer 150 may cover the entire exterior surface of the inner layer. Outer layer 150 inhibits, and preferably prevents liquids absorbed by the paperboard inner layer (e.g. via the upper surface 111 of the base portion 110) from leaking through the tray. Accordingly, despite the absorbency of the paperboard inner layer, tray 100 may be characterized overall as being water and/or grease resistant. The outer surface 152 of outer layer 150 may also inhibit or prevent liquids from being absorbed by the paperboard inner layer via the exterior surface 109 of the base portion 110.

Examples of suitable coatings include polylactic acid (PLA) or other bioplastics, although any suitable paint that converts into a liquid-impermeable film once applied could be used. Preferably, the coating is biodegradable (e.g. compostable) and/or recyclable. Outer layer 150 is preferably applied via spray coating, although other suitable coating methods (e.g. dip coating) may alternatively be used.

Providing a liquid-impermeable coating on the exterior surfaces of the paperboard inner layer (i.e. not on surfaces defining the interior volume of the tray) may have one or more advantages. For example, since these exterior surfaces do not, in normal use, come in contact with the contents of the tray (e.g. meat), the coating of the outer layer 150 may not have to be a food-grade coating.

Also, once the liquid-impermeable coating has been applied to the tray, outer surface 152 may also act as a barrier to prevent dyes or other liquids (e.g. adhesives for labeling) applied to the outer layer 150 from being absorbed by the paperboard inner layer. This may allow nutritional, marketing, or other labelling to be printed or otherwise applied directly to the tray. Also, this may allow non-food-grade dyes or other liquids to be used, which may allow for a wider variety of colours, designs, etc. to be applied to tray 100.

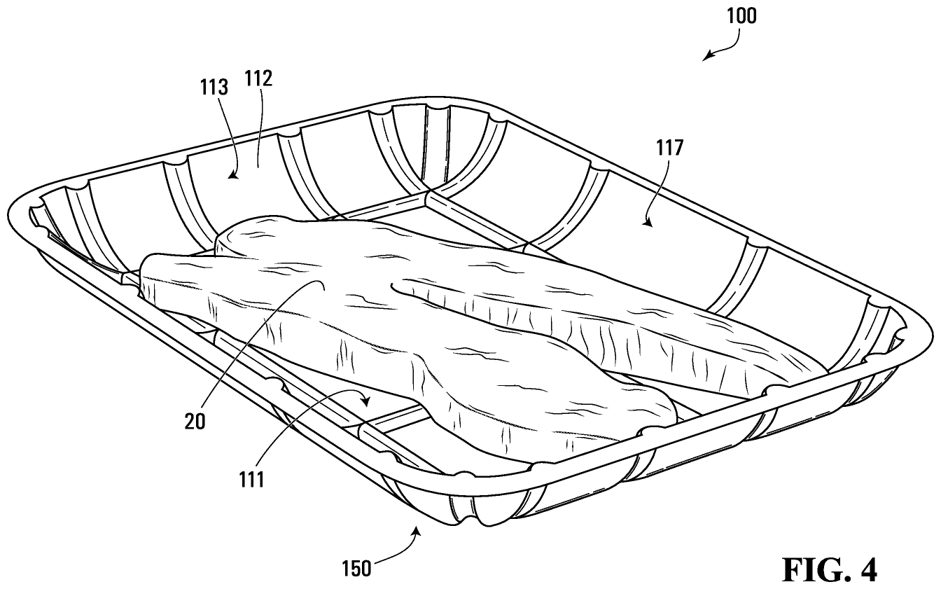

FIG. 4 illustrates a tray 100 in which two pieces of meat 20 have been placed. As discussed above, blood or other meat juices released by the meat 20 may be absorbed by the paperboard inner layer of the tray via upper surface 111 of the base portion 110, while the liquid-impermeable outer layer 150 inhibits these fluids from leaking through the tray.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A tray for inhibiting liquid released from an object placed in the tray from leaking through the tray, the tray comprising:
an integral absorbent inner layer having an uncoated inner surface and an exterior surface, the uncoated inner surface being configured to contact the object, the inner layer comprising:
a substantially planar base portion, the base portion having a perimeter; and
a wall portion extending upwardly from at least a portion of the perimeter;
an outer layer applied to the exterior surface of the inner layer, the outer layer comprising a liquid-impermeable coating;
wherein the inner layer consists of an absorbent paperboard, and
wherein the outer layer is adapted to inhibit liquid absorbed in the inner layer from leaking through the tray.

2. The tray of claim 1, wherein the wall portion extends from the entire perimeter and completely surrounds the base portion.

3. The tray of claim 1, wherein the outer layer is applied to the entire exterior surface of the inner layer.

4. The tray of claim 2, wherein the outer layer is applied to the entire exterior surface of the inner layer.

5. The tray of claim 1, wherein the absorbent paperboard comprises at least one of virgin wood fiber, food grade waste paper, wheat straw, and sugarcane bagasse.

6. The tray of claim 1, wherein the absorbent paperboard comprises at least one of virgin wood fiber, food grade waste paper, wheat straw, and sugarcane bagasse.

7. The tray of claim 2, wherein the absorbent paperboard comprises at least one of virgin wood fiber, food grade waste paper, wheat straw, and sugarcane bagasse.

8. The tray of claim 3, wherein the absorbent paperboard comprises at least one of virgin wood fiber, food grade waste paper, wheat straw, and sugarcane bagasse.

9. The tray of claim 1, wherein the liquid impermeable coating comprises polylactic acid (PLA).

10. The tray of claim 2, wherein the liquid impermeable coating comprises polylactic acid (PLA).

11. The tray of claim 3, wherein the liquid impermeable coating comprises polylactic acid (PLA).

12. The tray of claim 5, wherein the liquid impermeable coating comprises polylactic acid (PLA).

13. The tray of claim 1, wherein each of the absorbent paperboard and the liquid impermeable coating are biodegradable.

14. The tray of claim 2, wherein each of the absorbent paperboard and the liquid impermeable coating are biodegradable.

15. The tray of claim 3, wherein each of the absorbent paperboard and the liquid impermeable coating are biodegradable.

16. The tray of claim 5, wherein each of the absorbent paperboard and the liquid impermeable coating are biodegradable.

17. The tray of claim 9, wherein each of the absorbent paperboard and the liquid impermeable coating are biodegradable.
